(19) United States
(12) Patent Application Publication
(10) Pub. No.: US 2012/0155215 A1
(43) Pub. Date: Jun. 21, 2012

(54) RING MIXER

(76) Inventor: VISHAAL B. VERMA, Evanston, IL (US)

(21) Appl. No.: 13/330,468

(22) Filed: Dec. 19, 2011

Related U.S. Application Data
(60) Provisional application No. 61/459,679, filed on Dec. 17, 2010.

(51) Int. Cl. B01F 7/16

(52) U.S. Cl. 366/199; 366/200

(57) ABSTRACT

Embodiments relate to a mixing device including a mixer body and a mixing bowl. The mixer body has a circular housing defining at least one hole therein and contains a drive assembly. The mixing bowl defines a mixing bowl rotational axis and is removably connected to the mixer body, the mixing bowl is adapted to receive a mixing system defining a mixing system rotational axis and is removably connected to the drive assembly, the drive assembly rotates the mixing system about the mixing bowl rotational axis while simultaneously rotating the mixing system about the mixing system rotational axis.

### CLAIM FOR PRIORITY

This application claims priority from U.S. Provisional Application Ser. No. 61/459,679 filed Dec. 17, 2010, the complete subject matter of which is incorporated herein by reference in its entirety.

### FIELD OF THE INVENTION

The invention relates to food mixing appliances. More particularly, embodiments relate to a ring mixer having multiple beater blades which mix foods at different speeds.

### BACKGROUND OF THE INVENTION

Food blenders are well known in the art. Such blenders typically include a stand including a base and column portion which supports a detachable head at the top of the column. The head extends transversely across the base and laterally off the column so as to be positioned above a bowl. The position of the head makes it difficult to add material to the bowl while mixing. Further, such blenders typically are large, heavy, and inconvenient to store.

For the foregoing reasons, there is a need for a simple, lightweight mixing device that allows material to be added without obstruction to the bowl and is convenient to store.

### SUMMARY OF THE INVENTION

Embodiments relate to a mixing device. The mixing device includes a mixer body and a mixing bowl. The mixer body having a circular housing defining at least one hole therein and containing a drive assembly. The mixing bowl defines a rotational axis and is removably connected to the mixer body, the mixing bowl adapted to receive a mixing system defining a mixing system rotational axis and removably connected to the drive assembly, the drive assembly rotating the mixing system about the mixing bowl rotational axis while simultaneously rotating the mixing system about the mixing system rotational axis.

Another embodiment relates to a mixing device including a mixer body, a mixing system, a mixing bowl, and a base. The mixer body includes a circular housing defining at least one hole; a motor; and a drive assembly. The mixing system defines a mixing system rotational axis and detachably connected to the drive assembly. The mixing bowl is removably connected to the mixer body and includes a mixing chamber defining a mixing bowl rotational axis, the mixing bowl adapted to receive the mixing system, the drive assembly rotating the mixing system about the mixing bowl rotational axis while simultaneously rotating the mixing system about the mixing system rotational axis. The base is coupled to the mixing bowl and engaging a work surface.

Yet another embodiment relates to a method of operating a mixing device. In at least one embodiment, the material is added to the mixing bowl via the at least one hole. The drive assembly is engaged, rotating the mixing system about the mixing bowl rotational axis while simultaneously rotating the mixing system about the mixing system rotational axis. The material is mixed.

Still another embodiment relates to a method of operating a mixing device. The mixer device includes a mixer body having a circular housing defining at least one hole therein and containing a drive assembly; and a mixing bowl defining a mixing bowl rotational axis and removably connected to the mixer body, the mixing bowl is adapted to receive a mixing system defining a mixing system rotational axis and is removably connected to the drive assembly. The method includes placing mixer body relative to work surface allowing at least one mixing system mounting mechanism to be exposed and accessible; mounting at least one mixing system attachment proximate the at least one mixing system mounting mechanism; and locking the mixer body proximate the open end of the mixing bowl. The power drive system is engaged; the drive assembly is engaged, rotating the mixing system about the mixing bowl rotational axis while simultaneously rotating the mixing system about the mixing system rotational axis. A material is added to the mixing bowl via the at least one hole and mixed. The power drive system is disengaged; the mixer body is unlocked and removed. The at least one mixing system attachment is disengaged; the at least one mixing system attachment is placed within the mixing chamber and the mixer body is placed proximate the open end of the mixing bowl thus covering the at least one mixing system attachment and reducing the volume required during storage of ring mixer device.

The foregoing and other features and advantages of the invention will become further apparent from the following detailed description of the presently preferred embodiment, read in conjunction with the accompanying drawings. The drawings are not to scale. The detailed description and drawings are merely illustrative of the invention rather than limiting, the scope of the invention being defined by the appended claims and equivalents thereof.

### BRIEF DESCRIPTION OF THE DRAWINGS

FIG. 1 is an isometric view of a ring mixer device in accordance with one embodiment;

FIG. 2 is a top perspective view of the ring mixer device of FIG. 1 in accordance with one embodiment;

FIG. 3 is a side elevational view of the ring mixer device of FIG. 1 in accordance with one embodiment;

FIG. 4 is an exploded view of the ring mixer device of FIG. 1 in accordance with one embodiment;

FIG. 5 is an isometric view of the ring mixer body and mixer attachments of FIG. 1 in accordance with one embodiment;

FIG. 6 is an elevational view of the ring mixer device of FIG. 1 with the ring mixer body detached from the mixing bowl in accordance with one embodiment;

FIG. 7 is an isometric view of the ring mixer device of FIG. 1 with a product being added to the mixer body using the detachable funnel in accordance with one embodiment;

FIG. 8 is an isometric view of the ring mixer device showing the detachable funnel and whisk mixer attachments of FIG. 1 in accordance with one embodiment;

FIG. 9 is an isometric view of the ring mixer device of FIG. 1 illustrating the whisk mixer attachments being stored in the mixing bowl in accordance with one embodiment;

FIG. 10 is a cross-sectional view of the ring mixer device of FIG. 1 illustrating the latching mechanism disengaging the mixing bowl in accordance with one embodiment;

FIG. 11 is an enlarged view of Detail A of FIG. 10 illustrating the latching mechanism disengaging the mixing bowl in accordance with one embodiment;

FIG. 12 is a cross-sectional view of the ring mixer device of FIG. 1 illustrating the latching mechanism engaging the mixing bowl in accordance with one embodiment;

FIG. 13 is an enlarged view of Detail B of FIG. 12 illustrating the latching mechanism engaging the mixing bowl in accordance with one embodiment;

FIG. 14 is an elevational view of the mixing bowl of FIG. 1 having a standard flat surface with a rubber base ring in accordance with one embodiment;

FIG. 15 is a cross-sectional view of the mixing bowl of FIG. 14 taken along line A-A;

FIG. 16 is an elevational view of the mixing bowl of FIG. 1 having a twist-lock suction mechanism in accordance with one embodiment;

FIG. 17 is a cross-sectional view of the mixing bowl of FIG. 16 taken along line B-B;

FIG. 18 is an elevational view of the mixing bowl of FIG. 1 having a simple suction feature in accordance with one embodiment;

FIG. 19 is a cross-sectional view of the mixing bowl of FIG. 18 taken along line C-C;

FIG. 20 is an elevational view of the ring mixer device of FIG. 1 in accordance with one embodiment;

FIG. 21 is a cross-sectional view of the mixing bowl of FIG. 20 taken along line D-D illustrating the whisk mixing attachments positioned inside the mixing bowl;

FIG. 22 is an enlarged view of Detail C of FIG. 21 illustrating the internal mechanism of the mixer body in accordance with one embodiment;

FIG. 23 is an enlarged view of the whisk mixer attachment used with the mixer device of FIG. 1 at an angle of 0 degrees with respect to the center axis;

FIG. 24 is an enlarged view of the whisk mixer attachment used with the mixer device of FIG. 1 at any angle between 0 and 90 degrees with respect to the center axis;

FIG. 25 is an isometric view of the mixer body of the mixer device of FIG. 1 in accordance with one embodiment;

FIG. 26 is a top view of the mixer body of the mixer device of FIG. 25 in accordance with one embodiment;

FIG. 27 is an elevational view of the mixer body of the mixer device of FIG. 25 in accordance with one embodiment;

FIG. 28 is an exploded view of the mixer body of the mixer device of FIG. 1 in accordance with one embodiment;

FIG. 29 is a top view of the mixer device of FIG. 1 illustrating the whisk mixer attachments positioned in the mixer body in accordance with one embodiment;

FIG. 30 is a cut away view of the mixer device of FIG. 29 depicting the gear and drive assembly mounted inside the mixer body in accordance with one embodiment;

FIG. 31 is a cut away view of the mixer device illustrating one possible configuration of the drive assembly where the arrows indicate movement;

FIG. 32 is a cut away view of the mixer device illustrating a second possible configuration of the drive assembly where the arrows indicate movement;

FIG. 33 is a cut away view of the mixer device illustrating a third possible configuration of the drive assembly where the arrows indicate movement;

FIG. 34 is a cut away view of the mixer device illustrating a fourth possible configuration of the drive assembly where the arrows indicate movement;

FIG. 35 is a cut away view of the mixer device illustrating a fifth possible configuration of the drive assembly where the arrows indicate movement;

FIG. 36 is a cut away view of the mixer device illustrating a sixth possible configuration of the drive assembly where the arrows indicate movement;

FIG. 37 is a cut away view of the mixer device illustrating a seventh possible configuration of the drive assembly where the arrows indicate movement;

FIG. 38 is a cut away view of the mixer device illustrating an eighth possible configuration of the drive assembly where the arrows indicate movement;

FIG. 39 is a cut away view of the mixer device illustrating a ninth possible configuration of the drive assembly where the arrows indicate movement;

FIG. 40 is a cut away view of the mixer device illustrating a direct drive type (frameless motor) drive system in accordance with one embodiment;

FIG. 41 is a cut away view of the mixer device illustrating a slew drive type (a motor combined with a gear head or transmission) drive system in accordance with one embodiment; and

FIG. 42 is a cut away view of the mixer device illustrating a gear drive type (a motor combined with a gear head or transmission) drive system in accordance with one embodiment.

Throughout the various figures, like reference numbers refer to like elements.

### DETAILED DESCRIPTION OF PRESENTLY PREFERRED EMBODIMENTS

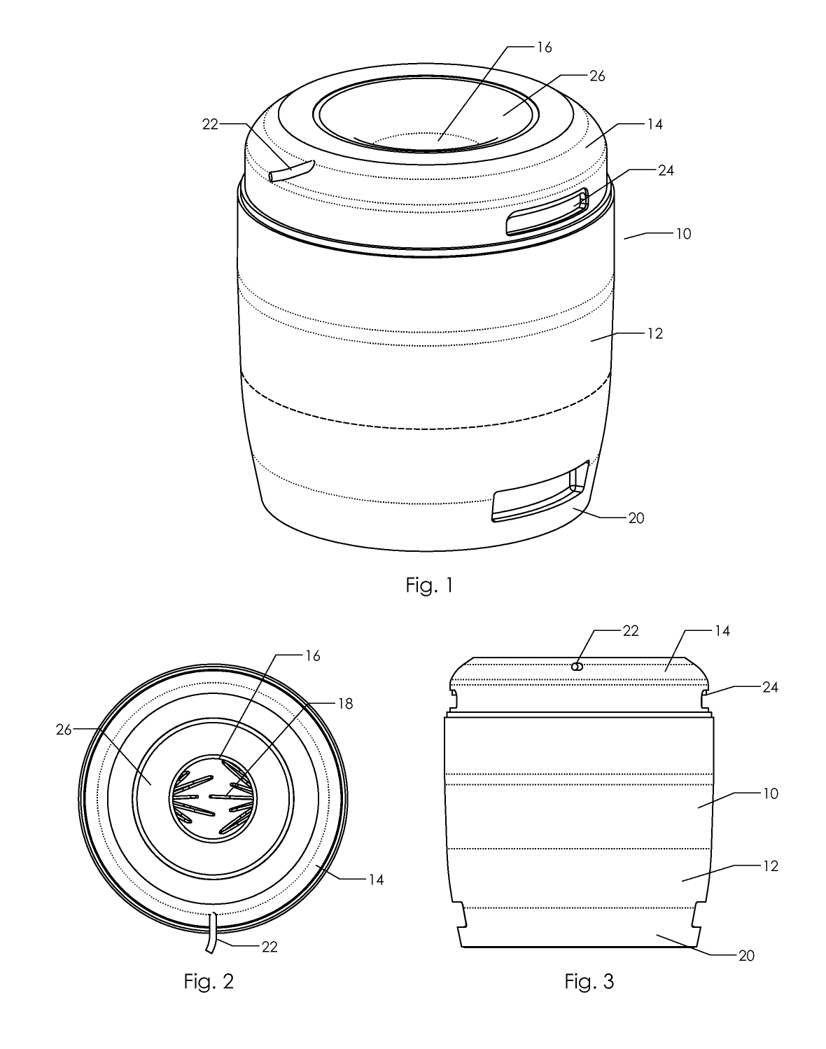

FIGS. 1-3 depict isometric, top, and side views of a ring mixer device, generally designated 10, in accordance with one embodiment, in a closed position. The ring mixer device 10 includes a mixing bowl 12 having a base configuration 20 at one end and a mixer body 14 at the opposing end. In at least one embodiment, the ring mixer body 14 has a drive assembly therein and a mixing system attached thereto, the mixing system comprises one or more mixer attachments 18 and removably attached to the ring mixer body 14. In one or more embodiments, the mixer attachments 18 may include a whisk, beater, dough hook, or other attachment devices.

FIGS. 1-3 depict a power cord 22 and latching mechanism 24 enabling the mixer body 14 to removably engage one end of the mixer bowl 12. In at least one embodiment, the mixer body 14 has a circular configuration defining at least one hole 16, where the hole 16 is in fluid communication with the mixing bowl 12. The at least one of the mixing bowl 12, mixer body 14, and hole 16 define a mixing bowl rotational axis R (best viewed in FIGS. 23 and 24), while the one or more mixer attachments 18 define a mixing system rotational axis R′ (best viewed in FIGS. 23 and 24). In at least one embodiment, the mixer body 14 and the drive assembly rotate the one or more whisk mixer attachments 18 about the mixing bowl rotational axis R while simultaneously rotating the one or more whisk mixer attachments 18 about the mixing system rotational axis R′.

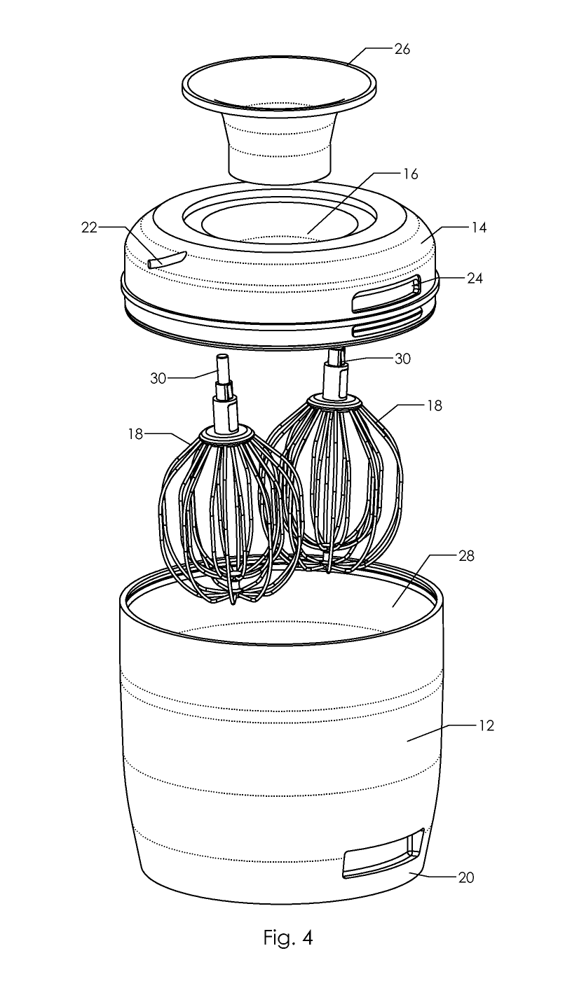

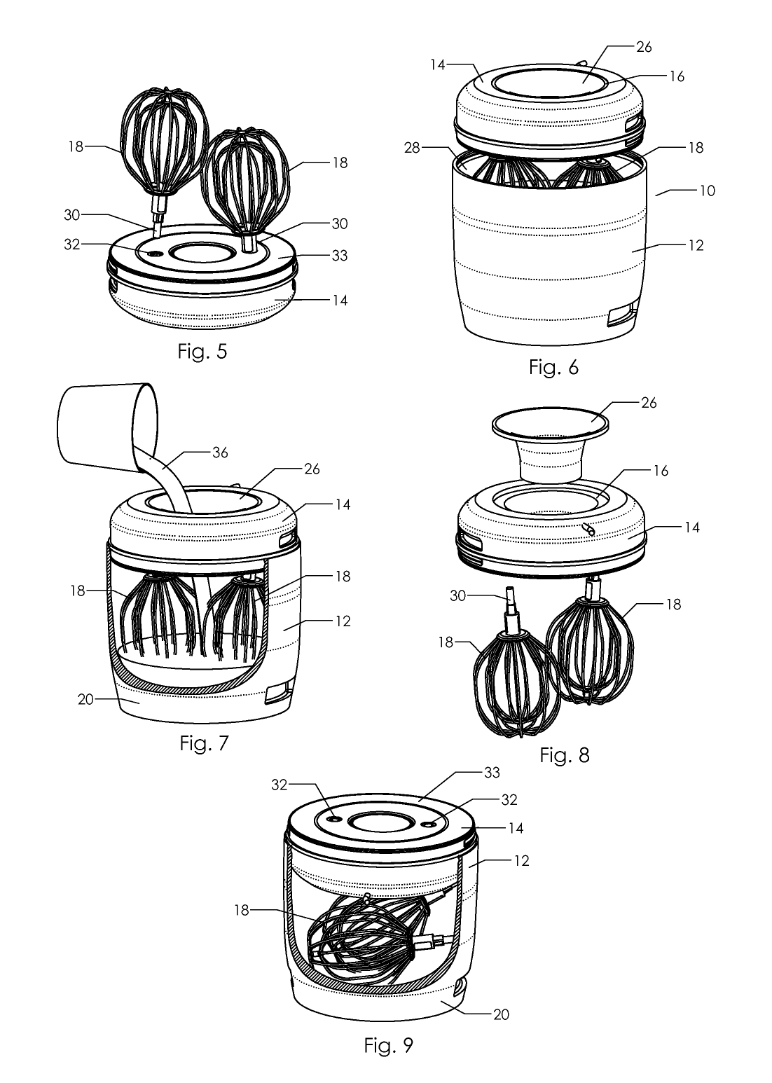

FIG. 4 is an exploded view of the ring mixer device of FIG. 1 in accordance with one embodiment. FIG. 4 illustrates the mixing bowl 12 defines a mixing chamber 28 in fluid communication with the at least one hole 16. FIG. 4 further illustrates the funnel 26 adapted to be moveably received in hole 16. The one or more whisk mixer attachments 18 having a stem 30 adapted to be removably received by the mixer body 14. FIG. 5 is an isometric view of the mixer body 14 and whisk mixer attachments 18 of FIG. 1 in accordance with one embodiment. FIG. 5 illustrates the mixer body 14 having surface 33 defining one or more attachment mounting points 32 adapted to removably receive the stems 30 of whisk mixer attachments 18, enabling the whisk mixer attachments 18 to engage the drive assembly. FIG. 6 is an elevational view of the ring mixer device of FIG. 1 with the mixer body 14 detached from the mixer bowl 12 in accordance with one embodiment illustrating the whisk mixer attachments 18. FIG. 7 is an isometric view of the ring mixer device 10 of FIG. 1 with a material 36 being added to the mixer body using the detachable funnel 26 in accordance with one embodiment.

FIGS. 5-7 illustrate one method of operating the mixing device 10. In at least one embodiment, the mixer body 14 is placed so that surface 33 and attachment mounting points 32 face upwards, and mixer attachments 18 are positioned in the attachment mounting points 32. The mixer body 14 is turned over and placed on the ring mixer body 12 such that the mixer attachments 18 extend into the mixing chamber 28 as illustrated in FIG. 6. The mixer pull tabs on opposing sides of the mixer body are pulled to retract the mixer mount latching mechanism 24. The mixer body 14 is mounted to the mixing bowl 12 by placing the mixer body 14 onto the mixing bowl 12 such that the mixer attachments 18 extend into the mixing chamber 28 as illustrated in FIG. 6, then the pull tabs are released.

The method of operation further includes, engaging the drive assembly, setting the mixer speed, rotating the mixing attachments 18 about the mixing bowl rotational axis R while simultaneously rotating the mixing system about the mixing system rotational axis R′. The ingredients or material 36 are poured into the opening or hole 16, and mixed.

FIG. 8 is an isometric view of the ring mixer device 10 showing the detachable funnel 26 and mixer attachments 18 of FIG. 1 in accordance with one embodiment; while FIG. 9 is an isometric view of the ring mixer device 10 of FIG. 1 illustrating the mixer attachments being stored in the mixing bowl. FIGS. 8 and 9 illustrate a method for storing the mixer device 10 when mixing is complete in accordance with one embodiment. The mixer body 14 is separated from the mixer bowl 12 using the mixer mount latching mechanism 24, along with the funnel 26 and mixer attachments 18. The mixer attachments 18 are placed into the mixing chamber 28 of the mixing bowl 12. The mixer body 14 is flipped upside down, nesting inside the mixing bowl 12, securing the mixer attachments in place and making storage convenient.

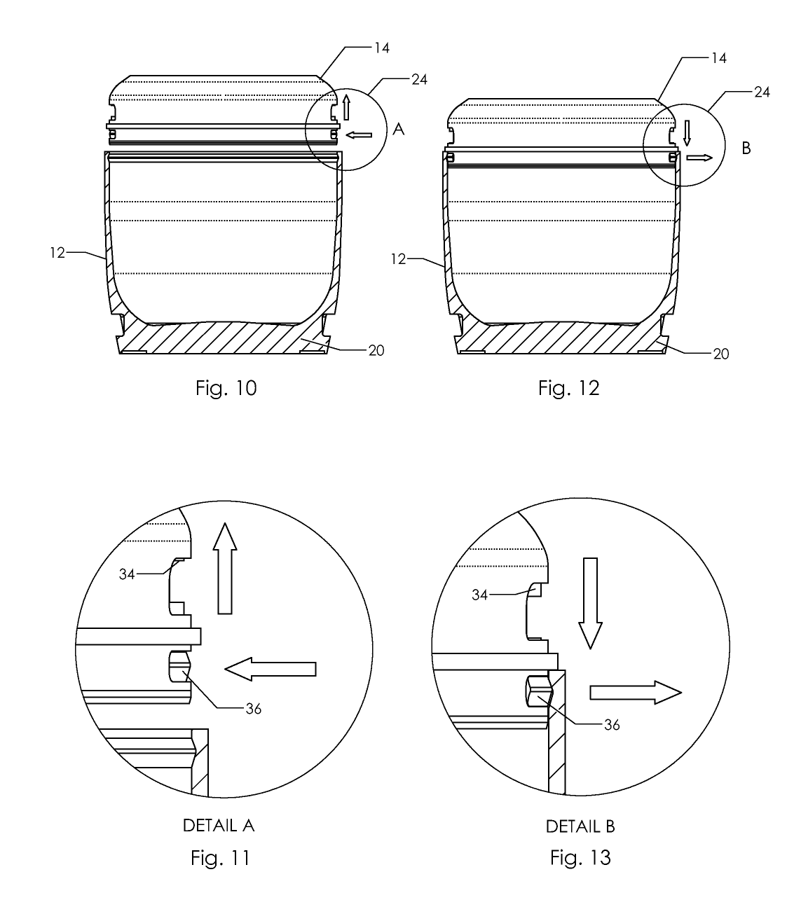

FIGS. 10 and 12 illustrate cross-sectional views of the ring mixer device 10 of FIG. 1 illustrating the latching mechanism 24 respectively disengaging and engaging the mixing bowl 12 in accordance with one embodiment. FIG. 11 is an enlarged view of Detail A of FIG. 10, while FIG. 12 is a cross-sectional view of the ring mixer device of FIG. 1 illustrating the latching mechanism engaging the mixing bowl in accordance with one embodiment. FIGS. 10 and 11 illustrate the latching mechanism 24 which secures the mixer body 14 to the mixing bowl 12. It is based on a simple mechanism where the upwards motion of the pull tab 34 (as indicated by the upward arrow in Detail A illustrated in FIG. 11) results in an inwards or retracted motion of the brake brackets 36 (as indicated by the sideways arrow in Detail A illustrated in FIG. 11). When the pull tabs 34 are released (as indicated by the downward arrow in Detail B illustrated in FIG. 13), the brake brackets 36 move outwards (as indicated by the sideways arrow in Detail B illustrated in FIG. 13), applying pressure to the mixer bowl 12 securing the mixer body 14 in a fixed position relative to the mixing bowl 12.

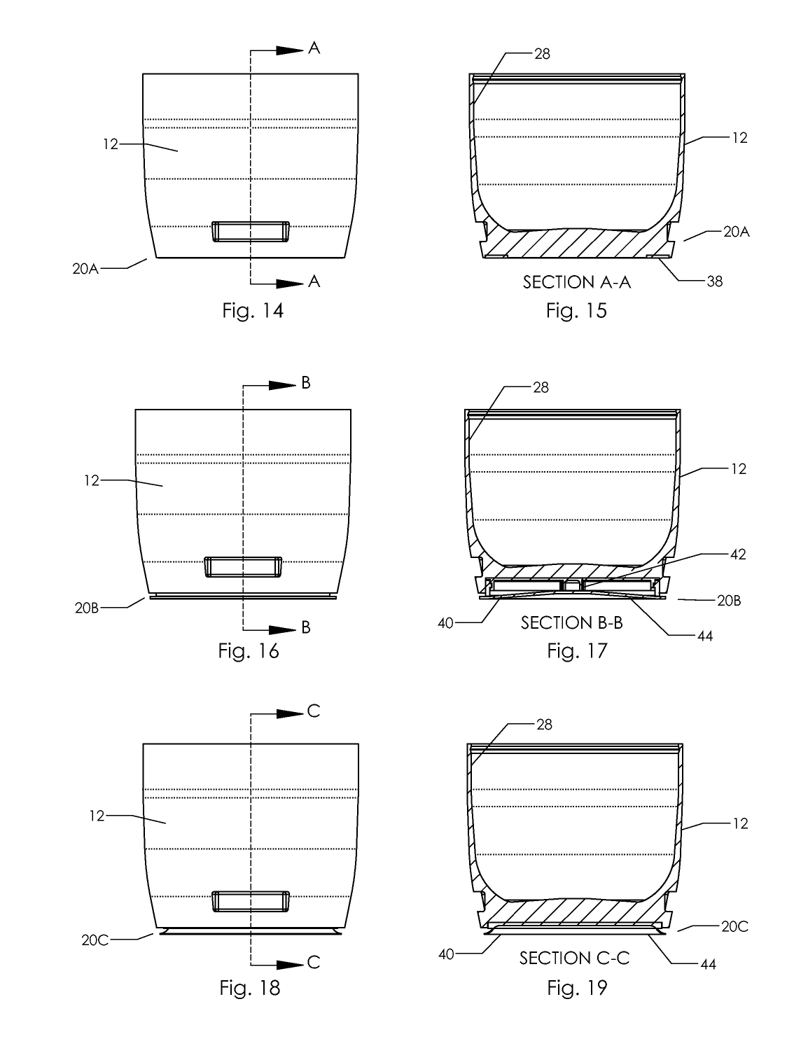

FIG. 14-19 depict elevational views of the mixing bowl of FIG. 1 having different base configurations 20 in removable contact with a work surface (table top or counter for example). FIG. 14 depicts an elevational view of the mixing bowl of FIG. 1, while FIG. 15 depicts a cross-sectional view of the mixing bowl of FIG. 14 taken along line A-A, having base configuration 20A, where base configuration 20A includes a rubber base ring 38 to provide a removable, non-skid interface or connection between the mixing bowl and the work surface.

FIG. 16 depicts an elevational view of the mixing bowl of FIG. 1, while FIG. 17 depicts a cross-sectional view of the mixing bowl of FIG. 16 taken along line B-B having base configuration 20B, where the base configuration includes a suction mechanism 40 including a twist-lock mechanism 42 to removably secure the ring mixer device 10 to the work surface. The suction mechanism 40 may include at least one suction pad 44 having a central portion connected to the base. The twist-lock mechanism 42 may further include a spring loaded engagement device, wherein turning the mixing bowl 12 in one direction about mixing bowl rotational axis R moves the central portion towards the work surface and turning the mixing bowl 12 in a second direction about mixing bowl rotational axis R moves the central portion away from the work surface thus forming a securing suction force between the mixing bowl and the work surface.

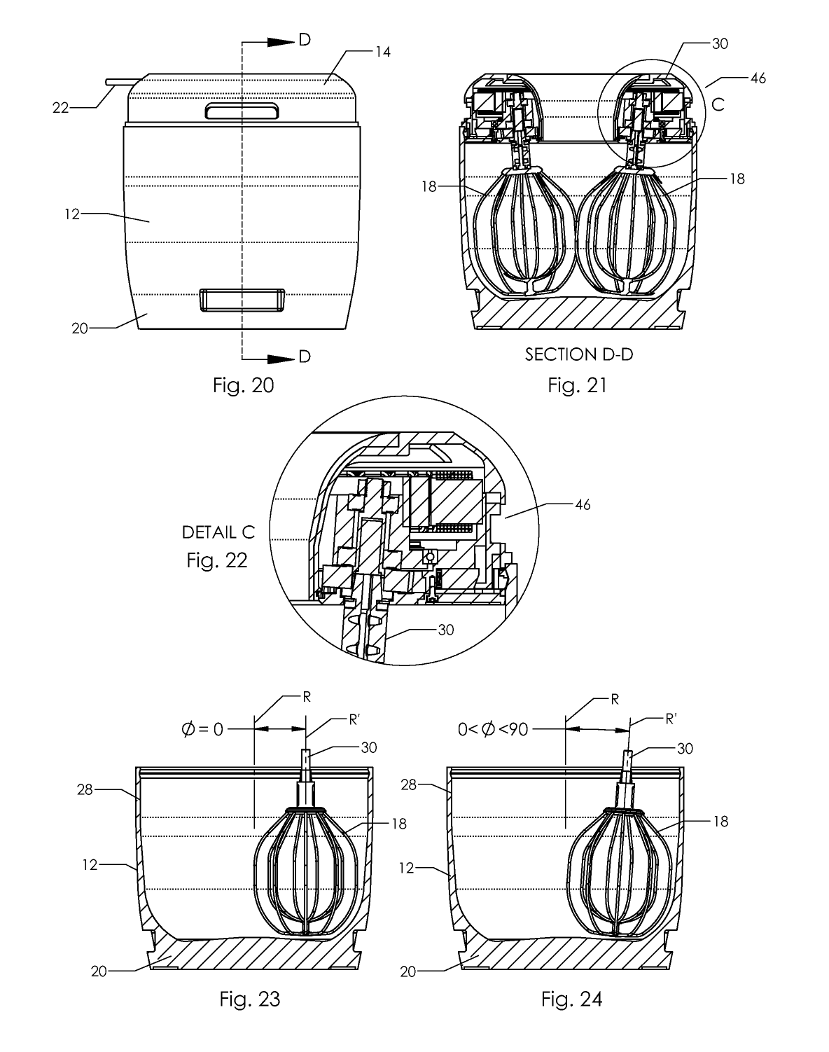

FIG. 18 depicts an elevational view of the mixing bowl of FIG. 1 having a simple suction feature in accordance with one embodiment; while FIG. 19 depicts a cross-sectional view of the mixing bowl of FIG. 18 taken along line C-C having base configuration 20C, where the base configuration includes a suction mechanism 40 to removably secure the ring mixer device 10 to the work surface. The suction mechanism 40 may include at least one suction pad 44 having a central portion connected to the base. Pushing down on the mixing bowl 12 in one direction moves the central portion towards the work surface and pushing the mixing bowl 12 in a second direction moves the central portion away from the work surface thus forming a securing suction force between the mixing bowl and the work surface.

FIG. 20 is an elevational view of the ring mixer device of FIG. 1 in accordance with one embodiment, while FIG. 21 is a cross-sectional view of the ring mixer device of FIG. 20 taken along line D-D illustrating the mixer attachments 18 positioned inside the mixer bowl 12, while FIG. 22 depicts an enlarged view of Detail C of FIG. 21 illustrating the internal mechanism of the mixer body 14 in accordance with one embodiment. FIGS. 21 and 22 illustrate the stems 30 engaging a drive device 46.

FIGS. 23 and 24 depict enlarged views of the mixer attachment 18 used with the ring mixer device 10 of FIG. 1 illustrating mixing bowl rotational axis R and mixing system rotational axis R′. FIG. 23 illustrates mixing bowl rotational axis R is parallel to the center axis of the mixing bowl while the mixing system rotational axis R′ is at an angle of 0 degrees with respect to the center axis and the mixing bowl rotational axis R. FIG. 24 illustrates the mixing bowl rotational axis R, while the one or more mixer attachments 18 define a mixing system rotational axis R′ at any angle between 0 and 90 degrees with respect to the center axis and the mixing bowl axis R.

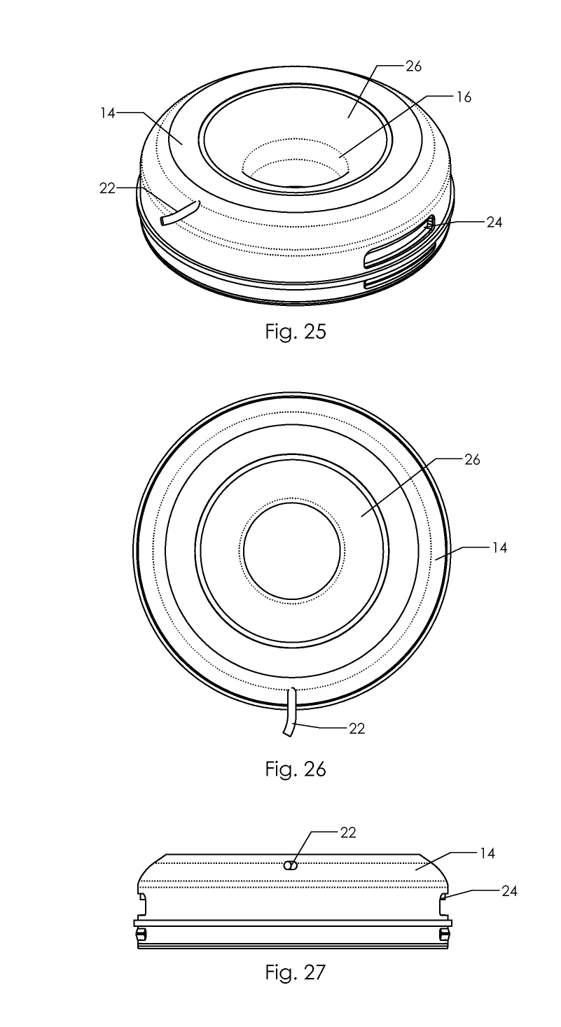

FIG. 25 depicts an isometric view of the mixer body 14 of the ring mixer device 10 of FIG. 1; FIG. 26 depicts a top view of the mixer body 14 of the ring mixer device 10 of FIG. 25, while FIG. 27 depicts an elevational view of the mixer body 14 of the mixer device 10 of FIG. 25 in accordance with one embodiment.

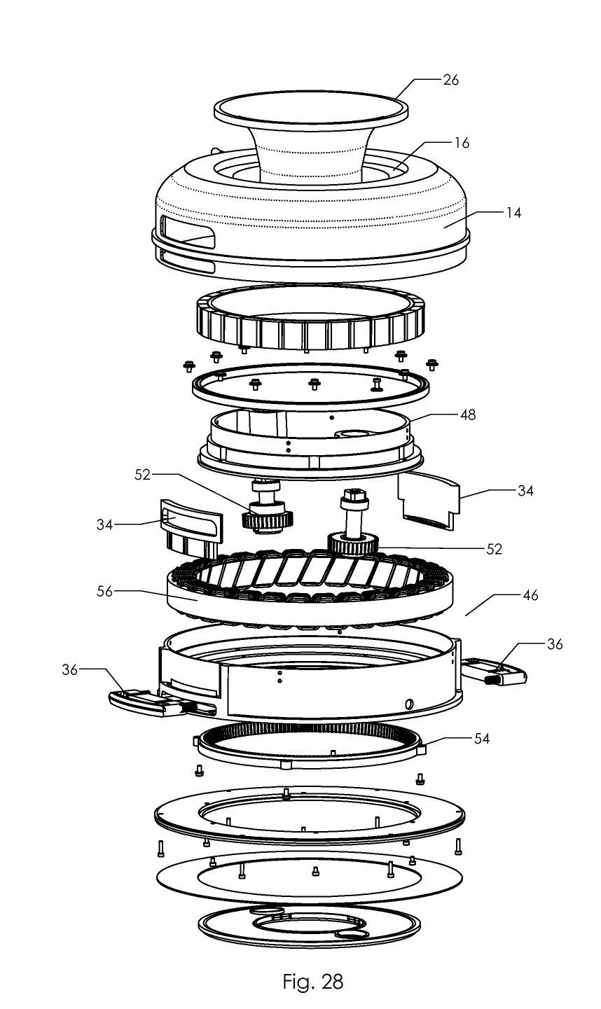

FIG. 28 depicts an exploded view of the mixer body of the ring mixer device of FIG. 1 in accordance with one embodiment. FIG. 28 illustrates mixer body 14, funnel 26, and latching mechanism 24 comprising pull tabs 34 and brake bracket 36. In at least one embodiment, the mixer body 14 includes a drive assembly 46 drive assembly that includes a planet carrier 48 contacting at least one but generally two rotatable planet gears 52 that removeably and moveably contact stems 30 of mixer attachments 18. The drive assembly 46 further includes a rotatable annulus gear 54 operably connected to a motor 56 and a sun gear 50 in a fixed position relative to the drive assembly and mixer body. In at least one embodiment, the annulus gear 54, sun gear 50, planet gears 52, planet carrier 48, and motor 56 are operably connected such that the mixer attachments 18 are simultaneously rotated about the mixing bowl rotational axis R and the mixing system rotational axis R′.

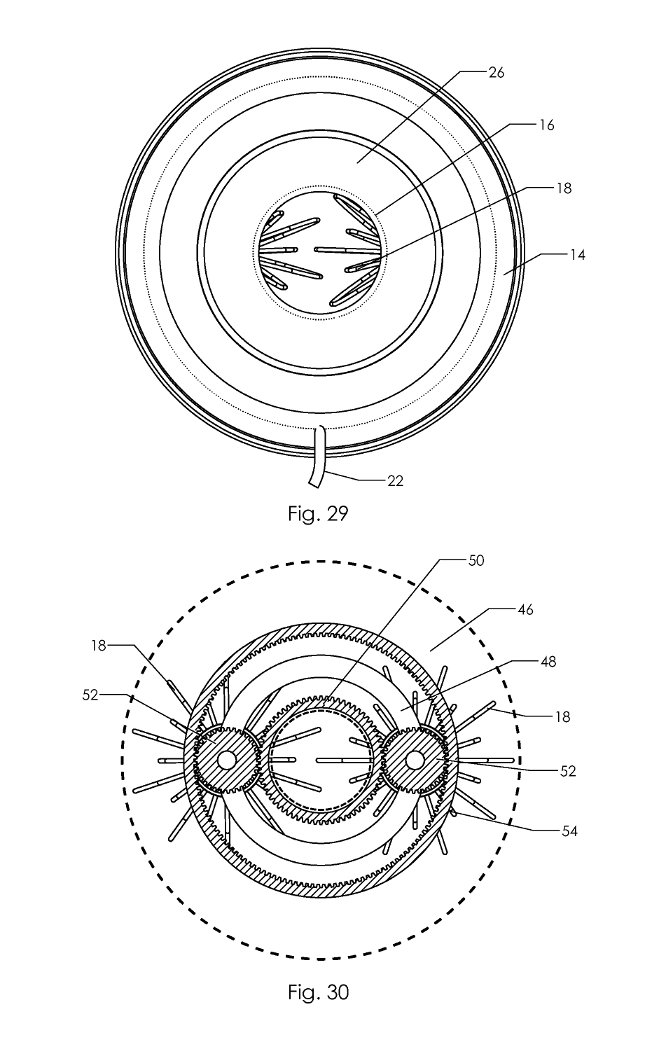

FIG. 29 is a top view of the ring mixer device 10 of FIG. 1 illustrating the mixer attachments 18 positioned in the mixer bowl 12 in accordance with one embodiment. FIG. 30 is a cut away view of the mixer device 10 of FIG. 29 depicting the drive assembly 46 mounted inside the mixer body 14 in accordance with one embodiment. The drive assembly 46 includes planet carrier 48, annulus gear 54, planet gears 52, and sun gear 50.

FIGS. 31-39 depict cut away views of the ring mixer device 10 illustrating possible configurations of the drive assembly 46 where the arrows indicate movement. FIG. 31 illustrates annulus gear 54 rotating in a counter-clock wise direction while the planet gears 52 are rotated simultaneously counter-clock wise about the mixing bowl rotational axis R and the mixing system rotational axis R′. The sun gear 50 is in a fixed position relative to the drive assembly and mixer body.

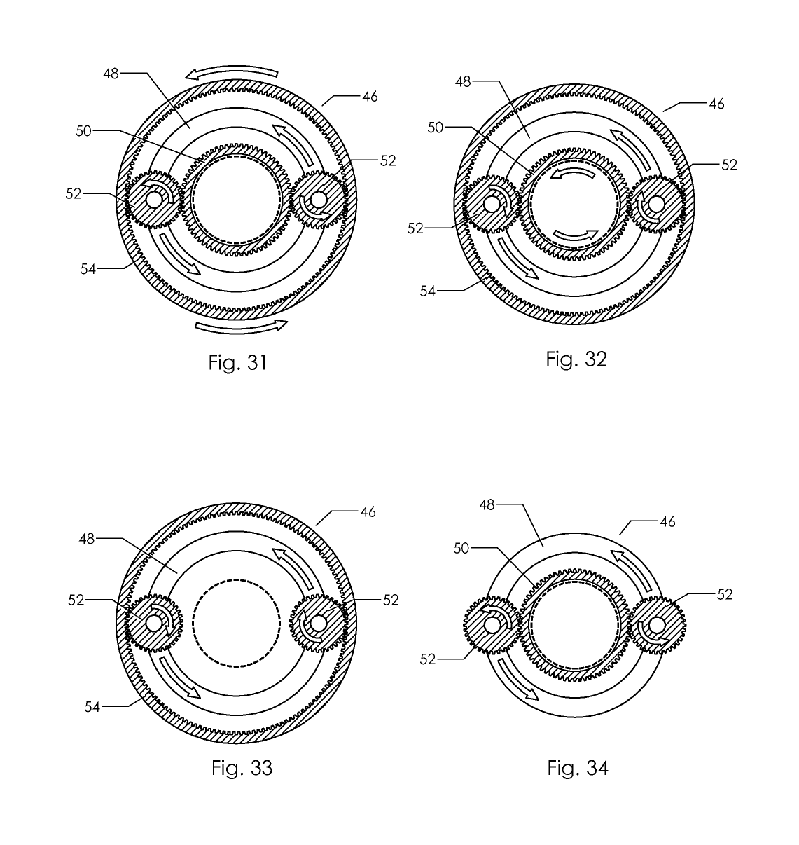

FIG. 32 is a cut away view of the ring mixer device 10 illustrating a second possible configuration of the drive assembly 46 where the sun gear 50 rotates in a counter-clock wise direction while the planet gears 52 are rotated simultaneously counter-clock wise about the mixing bowl rotational axis R and clock wise about the mixing system rotational axis R′. The annulus gear 54 is in a fixed position relative to the drive assembly and mixer body.

FIG. 33 is a cut away view of the ring mixer device 10 illustrating a third possible configuration of the drive assembly 46 where the planet gears 52 are rotated simultaneously counter-clock wise about the mixing bowl rotational axis R and clock wise about the mixing system rotational axis R′. The annulus gear 54 is in a fixed position relative to the drive assembly and mixer body.

FIG. 34 is a cut away view of the ring mixer device 10 illustrating a fourth possible configuration of the drive assembly 46 where the planet gears 52 are rotated simultaneously counter-clock wise about the mixing bowl rotational axis R and counter-clock wise about the mixing system rotational axis R′. The sun gear 50 is in a fixed position relative to the drive assembly and mixer body.

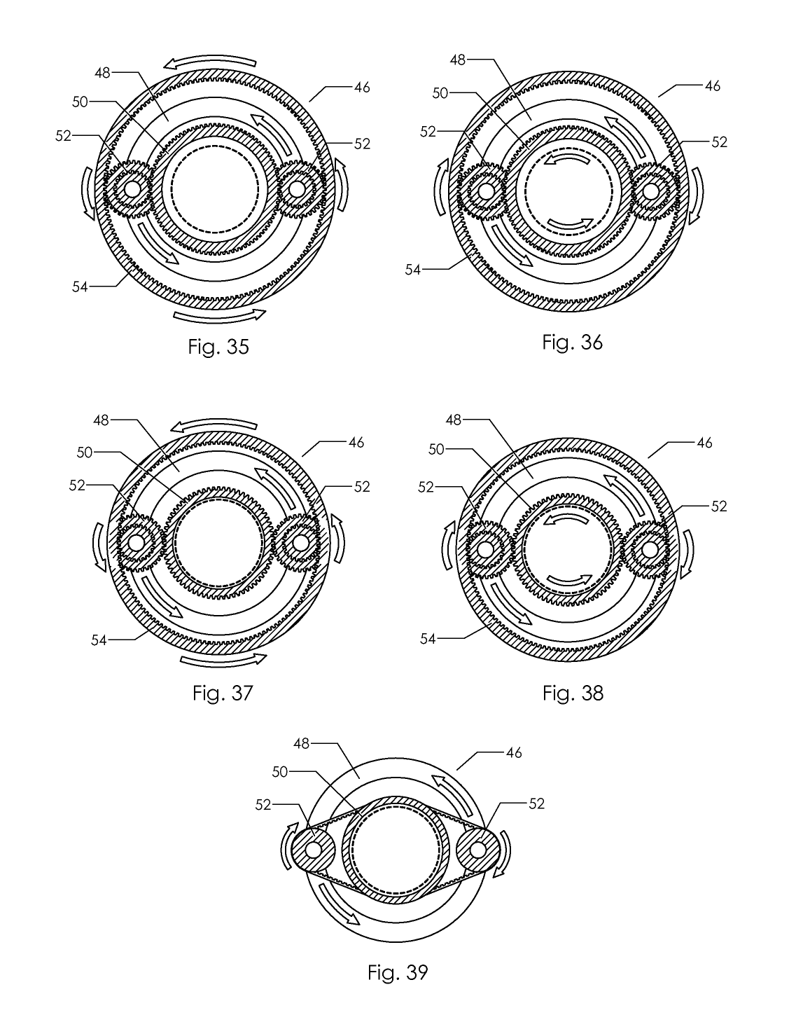

FIG. 35 is a cut away view of the ring mixer device 10 illustrating a fifth possible configuration of the drive assembly 46 where the annulus gear 54 rotates in a counter-clock wise direction and the annulus gear 50 rotates in a counter-clock wise direction, while the planet gears 52 containing a gear reduction from the annulus gear to the sun gear are rotated simultaneously counter-clock wise about the mixing bowl rotational axis R and counter-clock wise about the mixing system rotational axis R′. The sun gear 50 is in a fixed position relative to the drive assembly and mixer body.

FIG. 36 is a cut away view of the ring mixer device 10 illustrating a sixth possible configuration of the drive assembly 46 where the sun gear 50 rotates in a counter-clock wise direction, while the planet gears 52 containing a gear reduction from the annulus gear to the sun gear are rotated simultaneously counter-clock wise about the mixing bowl rotational axis R and clock wise about the mixing system rotational axis R′. The annulus gear 54 is in a fixed position relative to the drive assembly and mixer body.

FIG. 37 is a cut away view of the ring mixer device 10 illustrating a seventh possible configuration of the drive assembly 46 where the annulus gear 54 rotates in a counter-clock wise direction, while the planet gears 52 containing a gear reduction from the sun gear to the annulus gear are rotated simultaneously counter-clock wise about the mixing bowl rotational axis R and counter-clock wise about the mixing system rotational axis R′. The sun gear 50 is in a fixed position relative to the drive assembly and mixer body.

FIG. 38 is a cut away view of the ring mixer device 10 illustrating an eighth possible configuration of the drive assembly 46 where the sun gear 50 rotates in a counter-clock wise direction, while the planet gears 52 containing a gear reduction from the sun gear to the annulus gear are rotated simultaneously counter-clock wise about the mixing bowl rotational axis R and clock wise about the mixing system rotational axis R′. The annulus gear 54 is in a fixed position relative to the drive assembly and mixer body.

FIG. 39 is a cut away view of the ring mixer device 10 illustrating a ninth possible configuration of the drive assembly 46 incorporating a pulley driven planetary system where planet carrier 48 drives the planetary pulleys 52 simultaneously counter-clock wise about the mixing bowl rotational axis R and the clock wise about the mixing system rotational axis R′. The sun pulley 50 is in a fixed position relative to the drive assembly and mixer body.

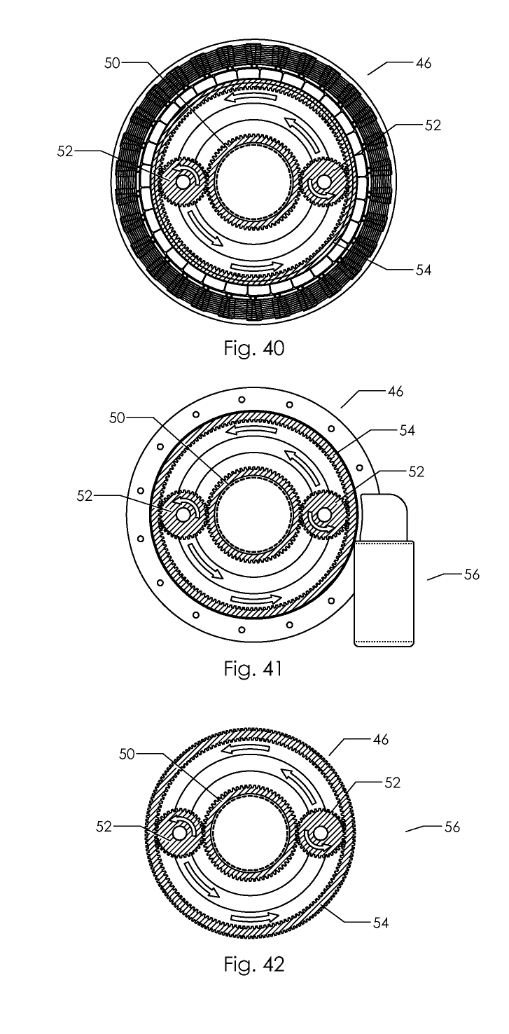

FIG. 40 is a cut away view of the ring mixer device 10 illustrating a (direct) drive type comprising (frameless) motor 56 directly coupled to annulus gear 54 which rotates in a counter-clock wise direction, while the planet gears 52 are rotated simultaneously counter-clock wise about the mixing bowl rotational axis R and clock wise about the mixing system rotational axis R′. The sun gear 50 is in a fixed position relative to the drive assembly and mixer body.

FIG. 41 is a cut away view of the ring mixer device 10 illustrating a slew drive type comprising a motor (in any configuration) indirectly coupled to the annulus gear 54 via a gear head or transmission which rotates in a counter-clock wise direction, while the planet gears 52 are rotated simultaneously counter-clock wise about the mixing bowl rotational axis R and clock wise about the mixing system rotational axis R′. The sun gear 50 is in a fixed position relative to the drive assembly and mixer body.

FIG. 42 is a cut away view of the ring mixer device 10 illustrating a gear drive type comprising a motor 56 indirectly coupled to annulus gear 54 via a drive gear (or transmission) which rotates in a counter-clock wise direction, while the planet gears 52 are rotated simultaneously counter-clock wise about the mixing bowl rotational axis R and clock wise about the mixing system rotational axis R′. The sun gear 50 is in a fixed position relative to the drive assembly and mixer body.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A mixing device comprising:
a mixer body having a circular housing defining at least one hole therein and containing a drive assembly; and
a mixing bowl defining a mixing bowl rotational axis and removably connected to the mixer body, the mixing bowl adapted to receive a mixing system defining a mixing system rotational axis and removably connected to the drive assembly, the drive assembly rotating the mixing system about the mixing bowl rotational axis while simultaneously rotating the mixing system about the mixing system rotational axis.

2. The mixing device of claim 1 wherein the mixing bowl defines a mixing chamber in fluid communication with the at least one hole.

3. The mixing device of claim 1 wherein the mixer body comprises any shape following the contour of at least one open end of the mixing bowl.

4. The mixing device of claim 1 wherein the mixer body comprises any shape as to prevent contained material from being expelled from any location around the opening of the mixing bowl.

5. The mixing device of claim 1 wherein the drive assembly includes at least one annulus gear.

6. The mixing device of claim 1 wherein the drive assembly includes at least one sun gear.

7. The mixing device of claim 1 wherein the drive assembly includes at least one sun gear and at least one annulus gear.

8. The mixing device of claim 7 wherein the drive assembly further includes at least one planet gear engaging the at least one annulus gear.

9. The mixing device of claim 8 wherein the drive assembly further includes at least one planet gear engaging the at least one sun gear.

10. The mixing device of claim 9 wherein the drive assembly further includes at least one planet gear engaging the at least one sun gear and the at least one annulus gear.

11. The mixing device of claim 1 wherein the drive assembly further includes at least one planet gear coupled to at least one mixer system attachment mounting mechanism.

12. The mixing device of claim 11 wherein the drive assembly further includes at least one mixer system mounting mechanism allowing the mixer system attachment to be detachably fixed rotationally and axially relative to the at least one planet gear.

13. The mixing device of claim 12 wherein the drive assembly further includes at least one planet carrier constraining the at least one planet gear about the mixing bowl rotational axis.

14. The mixing device of claim 13 wherein the drive assembly further includes at least one planet carrier coupling more than one planet gear.

15. The mixing device of claim 1 wherein the drive assembly includes at least one annulus gear attached directly or indirectly to a power drive system thus engaging the drive assembly.

16. The mixing device of claim 15 wherein the drive assembly includes at least one sun gear attached directly or indirectly to a power drive system thus engaging the drive assembly.

17. The mixing device of claim 16 wherein the drive assembly includes at least one planet carrier attached directly or indirectly to a power drive system thus engaging the drive assembly.

18. The mixing device of claim 1 further comprising a base removably connected to the mixing bowl and in contact with a work surface.

19. The mixing device of claim 18 wherein the base further comprises a locking mechanism to removably secure the base to the work surface.

20. The mixing device of claim 19 wherein the locking mechanism further comprises at least one suction pad having a central portion connected to the base.

21. The mixing device of claim 20 wherein the base further comprises a spring loaded engagement device, wherein moving the engagement device in one direction moves the central portion away from the work surface thus engaging a suction and securing the base to the work surface and moving the engagement device in another direction moves the central portion towards the work surface disengaging the suction and removing the base from the work surface.

22. The mixing device of claim 21 wherein turning the bowl in a first direction rotationally relative to mixing bowl rotational axis moves the central portion away from the work surface and moving the bowl in a second direction rotationally relative to mixing bowl rotational axis moves the central portion towards the work surface.

23. A mixing device comprising:
a mixer body comprising:
a circular housing defining at least one hole;
a drive assembly; and
a power drive system;
a mixing system defining a mixing system rotational axis and detachably connected to the drive assembly;
a mixing bowl removably connected to the mixer body comprising:
a mixing chamber defining a mixing bowl rotational axis, the mixing bowl adapted to receive the mixing system, the drive assembly rotating the mixing system about the mixing bowl rotational axis while simultaneously rotating the mixing system about the mixing system rotational axis; and
a base coupled to the mixing bowl and engaging a work surface.

24. The mixing device of claim 23 wherein the mixer body includes at least one handle opening or recess.

25. The mixing device of claim 24 wherein the mixer body includes at least one locking mechanism to secure the mixer body proximate the open end of the mixing bowl.

26. The mixing device of claim 25 wherein the mixer body includes at least one pull tab proximate the handle opening or recess adapted to movably engage at least one locking mechanism.

27. The mixing device of claim 25 wherein the mixer body includes at least one female or male thread engaging corresponding female or male thread located proximate the open end of the mixing bowl.

28. The mixing device of claim 25 wherein the mixer body includes at least one magnetic catch assembly movably engaging corresponding magnetic surface or catch assembly located proximate the open end of the mixing bowl.

29. The mixing device of claim 23 further including a detachable funnel positioned proximate the mixer body hole.

30. The mixing device of claim 23 wherein the base further includes:
a suction device adapted to engage a work surface; and
a securing engagement device coupled to the mixing bowl and the suction device and adapted to engage/disengage the suction device.

31. A method of operating a mixing device comprising:
the mixing device including a mixer body having a circular housing defining at least one hole therein and containing a drive assembly; and
a mixing bowl defining a mixing bowl rotational axis and removably connected to the mixer body, the mixing bowl adapted to receive a mixing system defining a mixing system rotational axis and removably connected to the drive assembly,
the method comprising:
placing mixer body relative to work surface allowing at least one mixing system mounting mechanism to be exposed and accessible;
mounting at least one mixing system attachment proximate the at least one mixing system mounting mechanism;
locking the mixer body proximate the open end of the mixing bowl;
engaging the power drive system;
engaging the drive assembly rotating the mixing system about the mixing bowl rotational axis while simultaneously rotating the mixing system about the mixing system rotational axis;
adding a material to the mixing bowl via the at least one hole;
mixing the material;
disengaging the power drive system;
unlocking and removing the mixer body;
disengaging the at least one mixing system attachment;
placing the at least one mixing system attachment within the mixing chamber; and
placing the mixer body proximate the open end of the mixing bowl thus covering the at least one mixing system attachment and reducing the volume required during storage of ring mixer device.
